(19) United States
(12) Patent Application Publication
(10) Pub. No.: US 2013/0179042 A1
(43) Pub. Date: Jul. 11, 2013

(54) METHOD AND SYSTEM FOR CALIBRATING ROLLOVER SETTINGS OF A VEHICLE

(71) Applicants: Beverly M. Katz, Livonia, MI (US); Anthony T. Freilach, Columbiaville, MI (US); James J. Hoeffel, Lake Orion, MI (US)

(72) Inventors: Beverly M. Katz, Livonia, MI (US); Anthony T. Freilach, Columbiaville, MI (US); James J. Hoeffel, Lake Orion, MI (US)

(73) Assignee: CHRYSLER GROUP LLC, Auburn Hills, MI (US)

(21) Appl. No.: 13/346,824

(22) Filed: Jan. 10, 2012

(51) Int. Cl. B60R 21/0132

(52) U.S. Cl. 701/46; 701/1

(57) ABSTRACT

A method and system for controlling rollover calibration settings of a vehicle is disclosed. The vehicle has a roll axis extending from a front end of the vehicle to a back end of the vehicle. The method comprises monitoring an off-road signal indicating whether the vehicle is operating in an off-road mode or a default mode, monitoring a speed signal indicative of the speed of the vehicle, and selecting the rollover calibration settings of the vehicle based on the off-road signal and the speed signal.

### FIELD

The present disclosure relates to a method and system for calibrating the rollover settings of a vehicle.

### BACKGROUND

Vehicles are configured to monitor the state of the vehicle to determine different types of collision situations. For example, vehicles are configured to monitor for a front-collision, a rear-collision, a side-collision, and a rollover collision. To do so, the vehicle may have a plurality of different sensors integrated throughout the vehicle to monitor for the different types of collisions. Depending on the type of collision, different collision operations may be performed. For instance, if a vehicle is involved in a front-collision, the vehicle may perform a front-collision operation, such as deploying the front-driver and front-passenger airbags and deploying the seatbelt pretensioners. If the vehicle is involved in a side-collision, the vehicle may perform a side-collision operation, e.g., deploying the side airbags but foregoing deploying the seatbelt pretensioners.

To monitor if the vehicle is in a rollover collision, the vehicle may monitor the roll-rate of the vehicle to determine if the vehicle is rolling over or about to rollover. The roll-rate is the angular velocity of the vehicle about the roll axis that axially extends from the front portion of the vehicle to the back portion of the vehicle. Typically, if the roll-rate exceeds a roll-rate threshold, the vehicle will determine that the vehicle is about to be involved in a rollover collision. As some vehicles are designed to drive on rugged or uneven terrain, i.e., “off-road,” the roll-rate of the vehicle may indicate to the vehicle that the vehicle is about to rollover, when in fact, the driver of the vehicle is merely driving on rugged terrain. In these instances, the vehicle may erroneously initiate a rollover collision operation, e.g., deploying the side-airbags and/or deploying the seatbelt pretensioners.

### SUMMARY

In one aspect of the disclosure, a method for controlling rollover calibration settings of a vehicle is disclosed. The vehicle has a roll axis extending from a front end of the vehicle to a back end of the vehicle. The method comprises monitoring an off-road signal indicating whether the vehicle is operating in an off-road mode or a default mode, monitoring a speed signal indicative of the speed of the vehicle, and selecting the rollover calibration settings of the vehicle based on the off-road signal and the speed signal.

In another aspect of the disclosure a system for controlling rollover calibration settings of a vehicle is disclosed. The vehicle has a roll axis extending from a front end of the vehicle to a back end of the vehicle. The system comprises a rollover calibration module that monitors an off-road signal indicating whether the vehicle is operating in an off-road mode or a default mode, that monitors a speed signal indicative of the speed of the vehicle, and that selects rollover calibration settings for the vehicle based on the off-road signal and the speed signal. The rollover calibration settings at least define conditions at which a rollover collision operation is performed by the vehicle. The system further comprises a deployment module that monitors a roll angle signal indicating a roll angle of the vehicle, the roll angle being indicative an amount of angular rotation of the vehicle about the roll axis of the vehicle, and that determines a roll-rate threshold based on the selected rollover calibration settings, and the roll angle signal. The roll-rate threshold defines a minimum roll-rate at which the rollover collision operation is performed by the vehicle and a roll-rate indicates an angular velocity of the vehicle about the roll axis of the vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1A is a drawing illustrating a top view of a vehicle and a roll axis of the vehicle;

FIG. 1B is a drawing illustrating a side view of a vehicle and a roll axis of the vehicle

FIG. 2 is a block diagram illustrating an example of a control module configured to trigger a rollover collision operation in response to detecting a rollover condition;

FIG. 3 is a flow chart illustrating an example of a method for determining a roll-rate threshold function;

FIG. 4 is a graph illustrating a first roll-rate threshold function and a second roll-rate threshold function; and

FIG. 5 is a flow chart illustrating an example of a method for determining when to initiate a rollover collision operation.

### DETAILED DESCRIPTION

As previously mentioned, some vehicles are designed to drive on rugged train or in “off-road” conditions. To facilitate such driving, these vehicles allow a user to select between four wheel drive (4WD) or two wheel drive (2WD). When a user is driving in an off-road condition, the user may be driving in a lower gear, i.e., first or second gear, and in four wheel drive. Further, some vehicles have specific settings which keep the vehicle in a low gear when in 4WD. To facilitate off-road driving, the vehicle is designed to handle an increased roll-rate when engaged on off-road terrain. Thus, to alleviate the situation when the vehicle is rotating about the roll axis at a roll-rate that would ordinarily trigger a rollover collision operation, a system and method is disclosed for determining when the vehicle is driving in an off-road mode and in off-road conditions and increasing a roll-rate threshold when said conditions are realized.

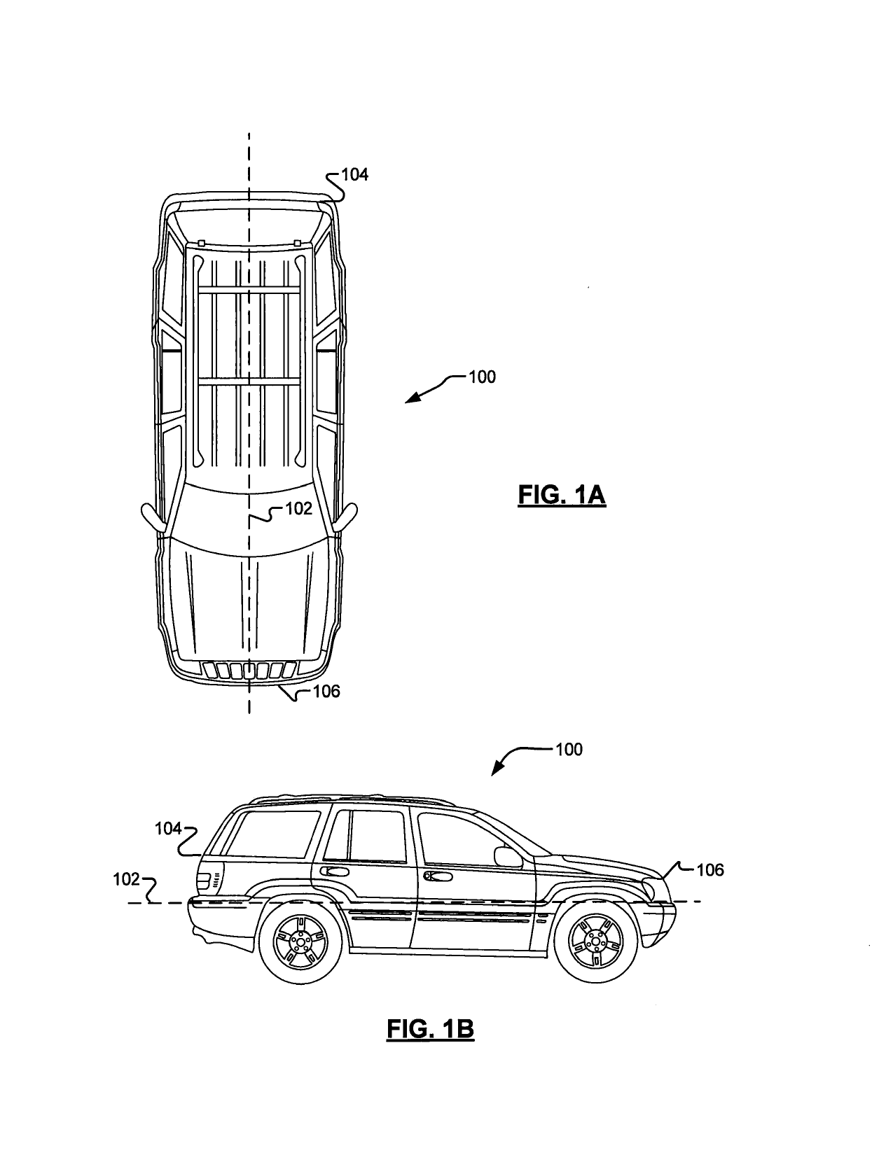

FIGS. 1A and 1B illustrate an example of a vehicle 100. FIG. 1A provides a top view of the vehicle 100 and FIG. 1B provides a side view of the vehicle 100. The vehicle 100 has a roll axis 102 axially extending from the back portion 104 of the vehicle to the front portion 106 of the vehicle. An amount of rotation about the roll axis 102 is used to determine a roll angle of the vehicle and an angular velocity about the roll axis 102 is used to determine a roll-rate of the vehicle 100. Ordinarily, when the roll-rate exceeds a roll-rate threshold, the vehicle 100 will initiate a rollover collision operation. A rollover collision operation may include, but is not limited to, deploying side airbags and deploying the pretensioners of the seatbelt. As will be described, the exact operations that are performed during a rollover collision operation can be set as part of the rollover calibration settings based on whether the vehicle 100 is in an off-road mode and driving in off-road conditions.

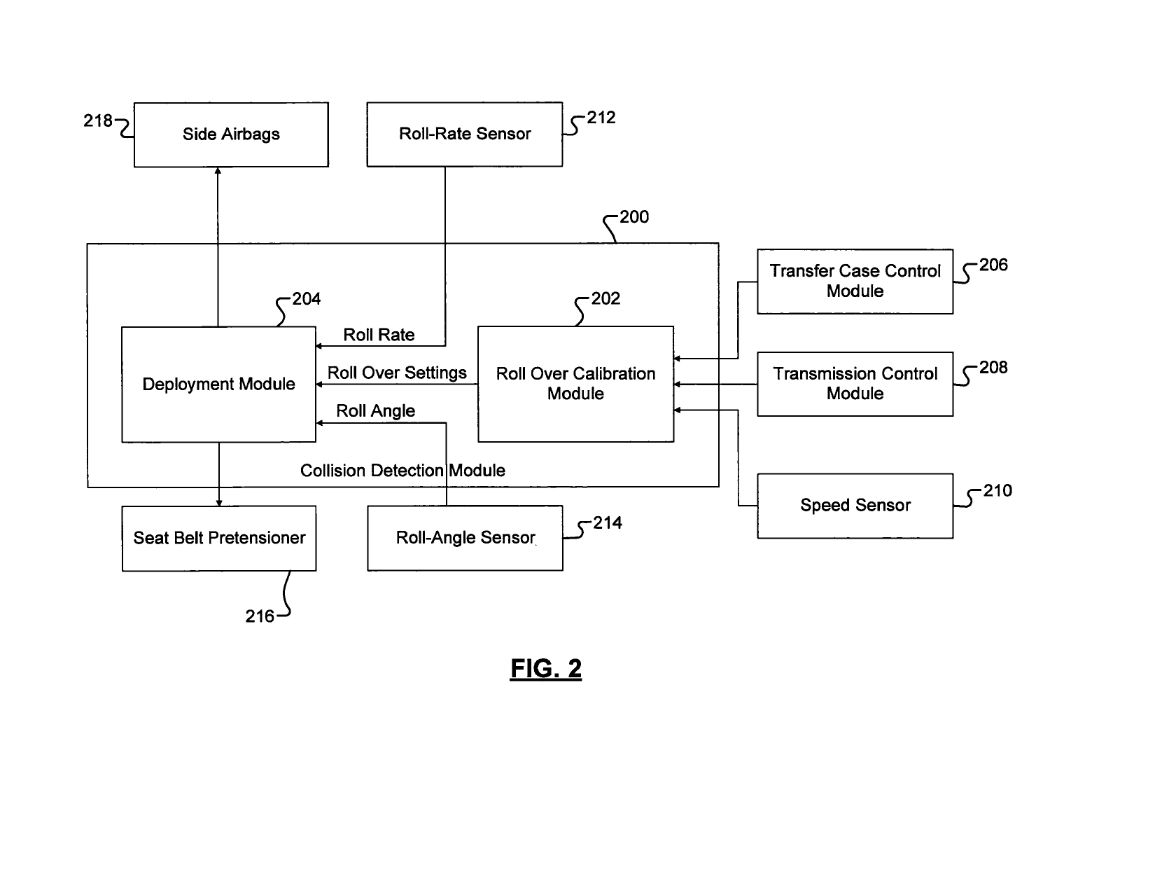

FIG. 2 illustrates an exemplary collision detection module 200. The collision detection module 200 is configured to monitor the condition of the vehicle 100 and to determine whether a collision has occurred, is occurring, or is about to occur. For example, the collision detection module 200 may have specific algorithms for determining whether a front-collision, a rear-collision, a side-collision, and/or a rollover collision is occurring or about to occur. In exemplary embodiments, the collision detection module 200 can include a rollover calibration module 202 and a deployment module 204. The rollover calibration module 202 may receive signals from a transfer case control module 206, a transmission control module 208, a speed sensor 210, and any other suitable sensor. The deployment module 204 may receive signals from a roll-rate sensor 212 and a roll angle sensor 214, as well as rollover calibration settings from the rollover calibration module 202. It is appreciated that the deployment module 204 may further receive signals from an accelerometer (not shown), a gyroscopic sensor (not shown) or any other sensor that assists the deployment module 204 classify a rollover event. The deployment module 204 may be further configured to control seatbelt pretensioners 216 and/or airbag systems 218 of the vehicle 100.

The rollover calibration module 202 is configured to determine whether the vehicle 100 is operating in an off-road mode or in a default mode, to monitor the speed of the vehicle 100, and to adjust the rollover calibration settings of the vehicle 100 based on whether the vehicle 100 is operating in an off-road mode and the speed of the vehicle 100. The deployment module 204 is configured to receive the rollover calibration settings from the rollover calibration module 202, to determine a roll-rate threshold value, and to determine whether the vehicle 100 is in a roll condition or about to be in a roll condition based on a roll angle.

In exemplary embodiments, the rollover calibration module 202 is configured to receive an off-road signal to determine whether to adjust the rollover calibration settings. The off-road signal includes a four wheel drive signal indicating whether the vehicle is operating in an off-road mode or a default mode and a speed signal indicating the speed of the vehicle 100. The off-road signal may be comprised of a four wheel drive signal and a gear signal. The four wheel drive signal is received from a transfer case control module 206 that controls the transfer case of the vehicle 100. The four wheel drive signal indicates whether the vehicle 100 is in 4WD or 2WD. The gear signal is received from a transmission control module 208 that controls the transmission of the vehicle 100. The gear signal indicates which gear the vehicle 100 is currently in. The off-road calibration module determines whether the vehicle is in an off-road mode, for example, if the four wheel drive signal indicates that the car is 4WD and the gear signal indicates that the vehicle is in one of first, second, and third gear.

In the exemplary embodiments, the rollover calibration module 202 further receives the speed signal from the speed sensor 210. The speed signal indicates the speed of the vehicle 100 at a particular time. As the speed of the vehicle 100 increases, the likelihood that a driver is engaged in off-road driving decreases. As will be discussed in greater detail below, in some embodiments, the rollover calibration module 202 compares the speed of the vehicle 100 with a speed threshold to determine whether the driver is likely engaged in off-road conditions. For example, if the vehicle 100 is driving at a speed that is greater than the speed threshold, e.g., 30 mph, then the rollover calibration module 202 can determine that the vehicle 100 is not being driven on an off-road terrain.

It is appreciated that the rollover calibration module 202 can further monitor additional signals to determine whether the vehicle 100 is driving off-road in an off-road mode. For instance, the rollover calibration module 202 can measure a shock absorber signal from the shock absorbers of the vehicle 100 or a electronic suspension of the vehicle 100. Further, the driver of the vehicle 100 can manually push a button that indicates that the driver is driving in off-road mode on an off-road terrain.

If the driver is driving below the speed threshold and is driving in an off-road mode, the rollover calibration module 202 may adjust the rollover calibration settings that are used by the deployment module 204 to determine if the vehicle 100 is in a rollover condition and which operations to perform if the vehicle 100 is in the rollover condition. In some embodiments, the rollover calibration module 202 will select a roll-rate threshold function to determine a roll-rate threshold. The selection is based on whether the vehicle 100 is driving in an off-road mode and driving on off-road terrain. The roll-rate threshold is a function used by the deployment module 204 to determine if the vehicle 100 is in a roll-collision. In some embodiments, the roll-rate threshold is a function of the roll angle of the vehicle 100 such that as the roll angle of the vehicle 100 increases, the roll-rate threshold decreases. Furthermore, in some embodiments, the roll-rate threshold function may be a linear function such that the roll-rate threshold function adheres to the form of y=mx+b. It is appreciated that the roll-rate threshold functions and other rollover calibration settings may be stored in a computer readable medium associated with the rollover calibration module 202.

Typically, if the vehicle 100 is operating in a default mode, i.e, 2WD, if the vehicle 100 is operating in 4WD but in a higher gear, or if the vehicle 100 is driving above the speed threshold, the rollover calibration module 202 will use a first roll-rate threshold function to determine the roll-rate threshold. If, however, the user is driving in an off-road mode and on off-road terrain, e.g., below a speed threshold, the rollover calibration module 202 selects a second roll-rate threshold function for determining the roll-rate threshold. It is appreciated that the rollover calibration module 202 may be further configured to change the rollover calibration settings of the vehicle 100. For instance, when a user is in an off-road mode, the rollover calibration module 202 may inhibit the deployment of the side airbags 218 when a rollover condition is sensed. Similarly, the rollover calibration module 202 may be configured to deploy reversible pretensioners 216 of the seatbelt if a rollover condition or collision is sensed by the rollover calibration module 202. It is appreciated that the foregoing rollover operations are for example only, and other rollover operations may be enabled when the vehicle is in an off-road mode, e.g., non-deployment of the pretensioners 216. Once the rollover calibration module 202 has selected one of the first roll-rate threshold function and the second roll-rate threshold function, as well as any other rollover calibration settings, the rollover calibration module 202 provides the selected rollover calibration settings, including the selected roll-rate threshold function to the deployment module 204. Accordingly, in some embodiments, the rollover calibration module 202 determines the rollover calibration settings based on the off-road signal and the speed signal and provides the rollover calibration settings to the deployment module 204.

The deployment module 204 is configured to receive the rollover calibration settings from the rollover calibration module 202, a roll-rate signal from a roll-rate sensor 212, and a roll angle signal from a roll angle sensor 214. As mentioned above, the rollover calibration module 202 may further receive a signal from an accelerometer or gyroscopic sensor. As previously discussed, the rollover calibration settings will include a roll-rate threshold function. Based on the received roll-rate threshold function and the roll angle of the vehicle, the deployment module 204 calculates a roll-rate threshold value. The deployment module 204 compares the received roll-rate of the vehicle 100 indicated by the roll-rate signal received from the roll-rate sensor 212 with the calculated roll-rate threshold to determine if the vehicle 100 is in a rollover condition. If the vehicle 100 is in a rollover condition, the deployment module 204 will initiate a rollover collision operation in accordance with the rollover calibration settings. For instance, if the vehicle 100 is driving in default mode, and the roll-rate indicates that a rollover condition is occurring or about to occur, the deployment module 204 may deploy the side airbags 218 and deploy the seatbelt pretensioners 216. If, however, the vehicle 100 is in an off-road mode and is driving at a speed that is below the speed threshold, the deployment module 204 may forego deploying the side airbags 218 and may deploy reversible seatbelt pretensioners 216.

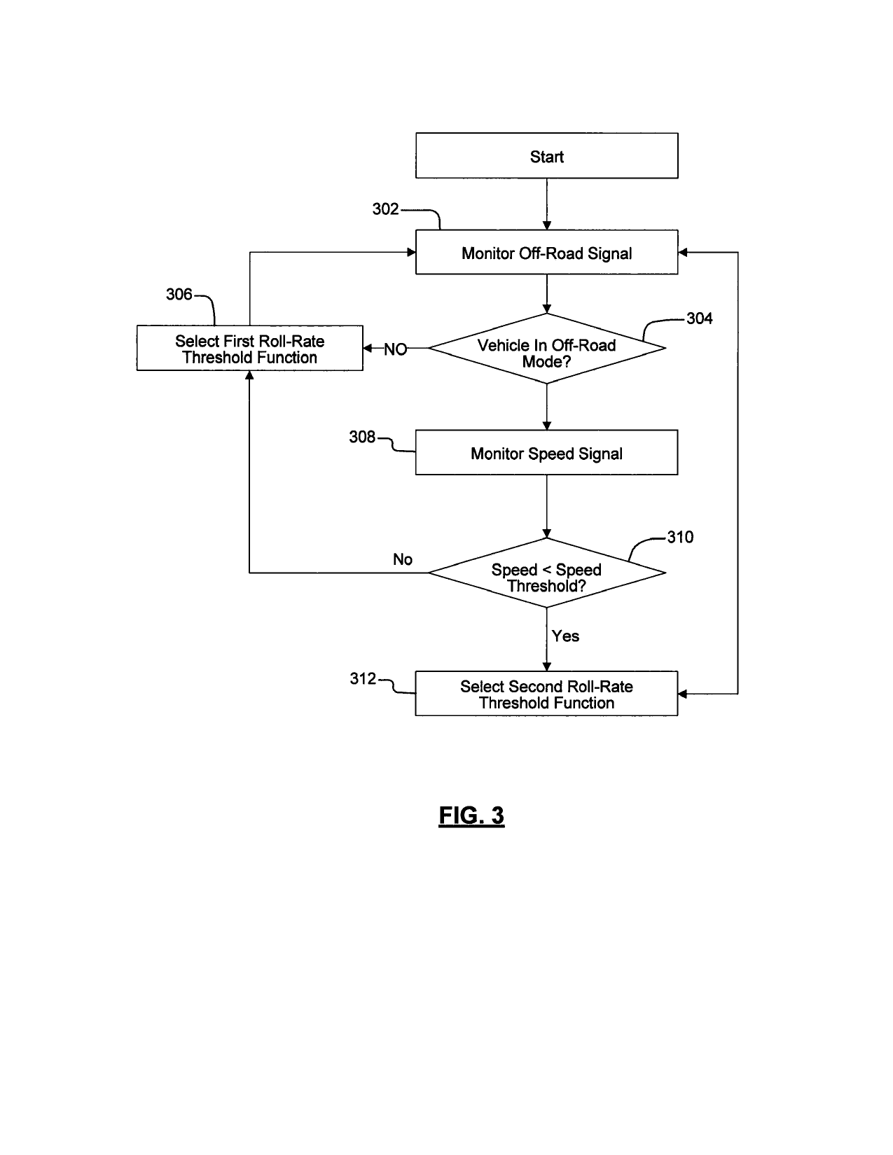

FIG. 3 illustrates an exemplary method 300 for selecting a threshold function. As previously mentioned, the rollover calibration module 202 monitors the off-road signal, as shown as step 302. It is appreciated that in some embodiments, the off-road signal may be received in combination from the transfer case control module 206 and the transmission control module 208. Alternatively, the driver may provide user input indicating that the user is driving in a four wheel drive mode, or any other sufficient means to determine whether the driver is driving in an off-road mode may also be used to generate an off-road signal. At step 304, the rollover calibration module 202 will determine whether the off-road signal indicates that the vehicle 100 is being operated in an off-road mode or in default mode. For example, if the four wheel drive signal received from the transfer case control module 206 indicates that the vehicle 100 is in 4WD and the gear signal received from the transmission control module 208 indicates that the vehicle 100 is operating in a low gear, then the vehicle 100 is determined to be in an off-road mode. Else, the vehicle 100 is determined to be in a default mode. If the vehicle 100 is being operated in the default mode, then the rollover calibration module 202 selects the first roll-rate threshold function, as shown at step 306. If, however, the vehicle 100 is working in the off-road mode, the rollover calibration module 202 monitors the speed signal received from the speed sensor 210, as shown at step 308. The rollover calibration module 202 compares the speed indicated by the speed signal with a speed threshold, as shown at step 310. If the speed is below the speed threshold, then the rollover calibration module 202 will select the second roll-rate threshold function, as shown at step 312. If the speed is above the speed threshold, the rollover calibration module 202 selects the first roll-rate threshold function, as shown at step 306.

It is appreciated that the rollover calibration module 202 can continuously execute the foregoing method and each time a determination is made of which roll-rate threshold function to use, the roll-rate threshold function is provided to the deployment module 204 at each iteration of the method 300. Additionally, the rollover calibration module 202 can further select additional rollover calibration settings corresponding to the selected roll-rate threshold function. Moreover, the rollover calibration module 202 may select from additional roll-rate threshold functions, as opposed to only two. This can be done based on additional speed thresholds or other signals. It is appreciated that the ordering of the steps may be varied and that some of the steps may be performed in a single step or may be divided into multiple steps.

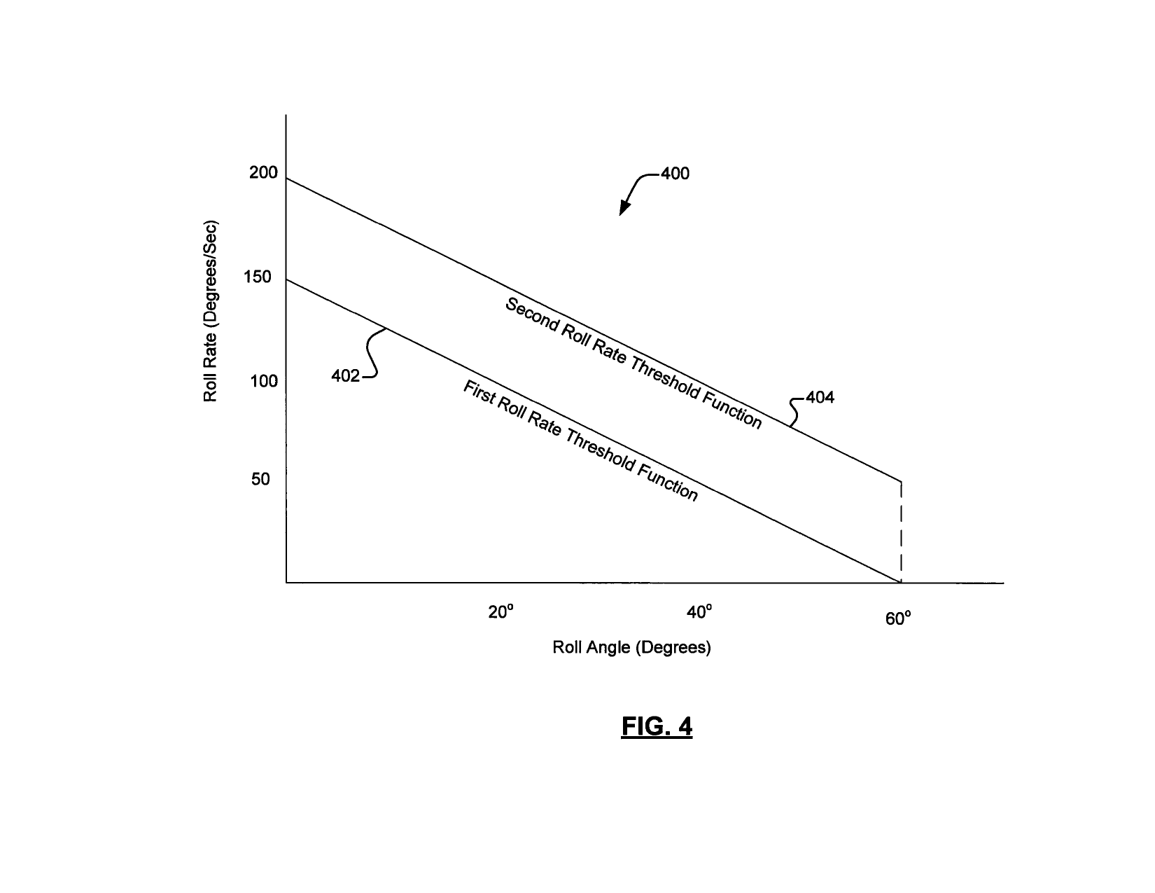

FIG. 4 illustrates a graph 400 which depicts an exemplary first roll-rate threshold function 402 and an exemplary second roll-rate threshold function 404. As was previously discussed, the roll-rate threshold is a function of the roll angle. As the roll angle of the vehicle 100 increases, the roll-rate threshold function decreases. Furthermore, once the roll angle of the vehicle 100 reaches a “point-of-no-return” angle, e.g., approximately 60 degrees in some vehicles, the vehicle 100 is extremely likely to rollover, even if the roll-rate is zero or close to zero. Thus, if the roll angle of the vehicle is greater than the “point-of-no-return” angle, the vehicle 100 is automatically considered to be in a roll condition.

The first roll-rate threshold function 402 corresponds to when a user is driving in a default mode or when the user is driving in an off-road mode but above the speed threshold. The first roll-rate threshold function 402 is defined by an equation of ωₘₐₓ=m₁Θ+b₁ where b₁ is the roll-rate threshold value when the roll angle is zero. The second roll-rate threshold function 404 corresponds to when the user is driving in an off-road mode and at a speed that is below the speed threshold. The second roll-rate threshold function 404 is defined by ωₘₐₓ=m₂Θ+b₂ where b₂ is equal to the roll-rate threshold when the roll angle is zero. It is appreciated that b₂ is greater than b₁ and in some embodiments, the slopes of the threshold functions, i.e., m₁ and m₂, may be equal. Furthermore, once the roll angle reaches the point-of-no-return angle, e.g., sixty degrees, the roll-rate threshold is set to zero. It is appreciated that while linear function is shown, other types of functions such as exponential decay, nonlinear decay, and other decreasing functions may be used.

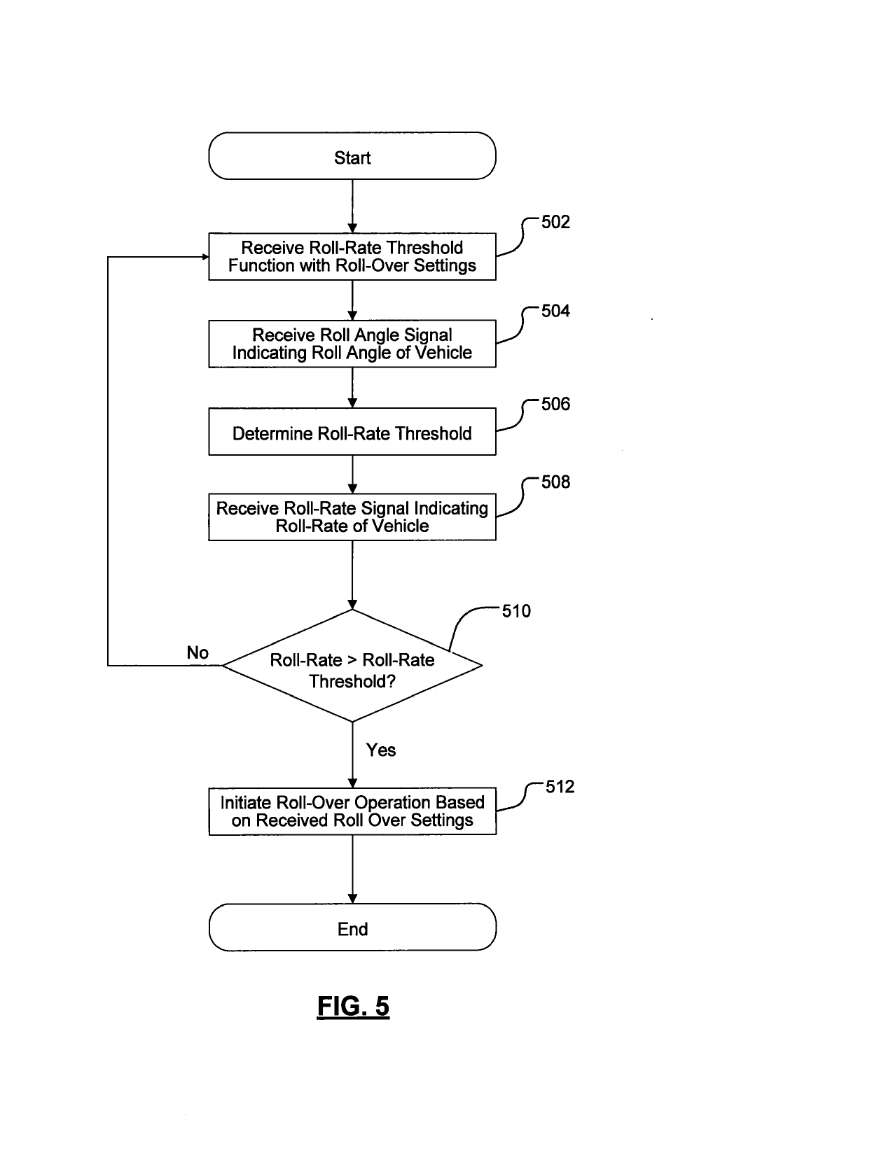

FIG. 5 illustrates an exemplary method that may be executed by the deployment module 204 for determining when to perform a rollover collision operation. The deployment module 204 is continuously receiving the rollover calibration settings from the rollover calibration module 202, as shown at step 502. As previously indicated, the rollover calibration settings will include the roll-rate threshold function, which was selected by the rollover calibration module 202 based on the off-road signal and the speed signal. The deployment module 204 further receives a roll angle signal indicating a roll angle of the vehicle 100 about the roll axis 102 of the vehicle 100, as shown at step 504. As discussed above, additional sensor data may be obtained from other sensors, e.g., an accelerometer or a gyroscopic sensor. Based on the roll-rate threshold function, the deployment module 204 will determine the roll-rate threshold based on the received roll-rate threshold function and the received roll angle, as shown at step 506. It is appreciated that the deployment module 204 will substitute the received roll angle signal into the roll-rate threshold function to determine the roll-rate threshold, ωₘₐₓ.

The deployment module 204 monitors the roll-rate signal to determine a roll-rate of the vehicle 100, as shown at step 508. The roll-rate of the vehicle 100 is compared with the roll-rate threshold to determine if the vehicle 100 is in a rollover condition, as shown at step 510. If the roll-rate is less than the roll-rate threshold, then the deployment module 204 will continue to monitor the condition of the vehicle 100 thereby returning to step 502. If, however, the roll-rate is greater than the roll-rate threshold, then the deployment module 204 initiates a rollover collision operation in accordance with the received rollover calibration settings, as shown at step 512. As previously discussed, depending on whether the vehicle 100 is in off-road mode or in a default mode and the speed of the vehicle 100, the rollover calibration settings may be modified to handle different conditions. Thus, the rollover collision operation that is initiated by the deployment module 204 may depend on the off-road signal and the speed signal. To initiate the rollover collision operation, the deployment module 204 may perform an operation as defined by the rollover calibration settings. For example, the deployment module may deploy the side airbags 218 and/or deploy the seatbelt pretensioners 216.

It is appreciated that variations of this method may exist. Furthermore, some of the steps may be performed in multiple substeps, while multiple steps may be performed in a single step. It is appreciated that the variations of the method 500 are within the scope of the disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The term module may include memory (shared, dedicated, or group) that stores code executed by the one or more processors.

The term code, as used above, may include software, firmware, bytecode and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for controlling rollover calibration settings of a vehicle, the vehicle having a roll axis extending from a front end of the vehicle to a back end of the vehicle, the method comprising:
monitoring an off-road signal indicating whether the vehicle is operating in an off-road mode or a default mode;
monitoring a speed signal indicative of the speed of the vehicle; and
selecting the rollover calibration settings of the vehicle based on the off-road signal and the speed signal.

2. The method of claim 1 further comprising:
monitoring a roll angle signal indicating a roll angle of the vehicle, the roll angle being indicative an amount of angular rotation of the vehicle about the roll axis of the vehicle; and
determining a roll-rate threshold based on the selected rollover calibration settings, and the roll angle signal, wherein the roll-rate threshold defines a minimum roll-rate at which a rollover collision operation is performed by the vehicle and a roll-rate indicates an angular velocity of the vehicle about the roll axis of the vehicle.

3. The method of claim 2 wherein determining a rollover rate threshold comprises selecting one of a first roll-rate threshold function and a second roll-rate threshold function based on the off-road signal and the speed signal, wherein the first roll-rate threshold function and the second roll-rate function define the roll-rate threshold as a function of a roll angle parameter, and wherein the second roll-rate threshold function is selected when the off-road signal indicates that the vehicle is operating in an off-road mode and the speed signal indicates that the speed of the vehicle is below a speed threshold.

4. The method of claim 3 wherein determining a roll rate threshold further comprises calculating the roll-rate threshold using the selected one of the first roll-rate threshold function and the second roll-rate threshold function, and the measured roll angle of the vehicle indicated by the roll angle signal, wherein the measured roll angle is substituted for the roll angle parameter.

5. The method of claim 3 wherein the first roll-rate threshold function is defined by:
ω_{MAX}=m₁θ+b₁
and the second roll-rate threshold function is defined by:
ω_{MAX}=m₂θ+b₂
where ω_{MAX} is the roll-rate threshold, m is a negative slope value, θ is the roll angle parameter, and b₁ and b₂ are offset values, wherein b₂ is greater than b₁.

6. The method of claim 2 further comprising
monitoring a roll rate signal indicative of a measured angular velocity of the vehicle about the roll axis of the vehicle;
comparing the measured angular velocity of the vehicle with the roll rate threshold; and
performing the rollover collision operation when the measured angular velocity of the vehicle exceeds the roll-rate threshold.

7. The method of claim 2 wherein when the off-road signal indicates that the vehicle is in the off-road mode and the speed signal indicates that the speed of the vehicle is below a speed threshold, the rollover collision operation includes at least one of deploying at least one side airbag of the vehicle, deploying a pretensioner of at least one seatbelt of the vehicle, and deploying a reversible pretensioner of the at least one seatbelt of the vehicle.

8. The method of claim 1 wherein adjusting the rollover calibration settings includes disengaging a side airbag system of the vehicle when the off-road signal indicates that the vehicle is operating in an off-road mode and the speed signal indicates that the speed of the vehicle is below a speed threshold.

9. The method of claim 1 wherein adjusting the rollover calibration settings includes allowing an engaged pretensioner of a seatbelt of the vehicle to disengage when the off-road signal indicates that the vehicle is operating in an off-road mode and the speed signal indicates that the speed of the vehicle is below a speed threshold.

10. The method of claim 1 wherein the off-road signal is comprised of a four wheel drive signal indicating whether the vehicle is in a two-wheel drive mode or a four-wheel drive mode and a gear signal indicating a current gear of the vehicle, wherein the four wheel drive signal is received from a transfer case control module of the vehicle and the gear signal is received from a transmission control module of the vehicle.

11. A system for controlling rollover calibration settings of a vehicle, the vehicle having a roll axis extending from a front end of the vehicle to a back end of the vehicle, the system comprising:
a rollover calibration module that monitors an off-road signal indicating whether the vehicle is operating in an off-road mode or a default mode, that monitors a speed signal indicative of the speed of the vehicle, and that selects rollover calibration settings for the vehicle based on the off-road signal and the speed signal, the rollover calibration settings at least defining conditions at which a rollover collision operation is performed by the vehicle; and
a deployment module that monitors a roll angle signal indicating a roll angle of the vehicle, the roll angle being indicative an amount of angular rotation of the vehicle about the roll axis of the vehicle, and that determines a roll-rate threshold based on the selected rollover calibration settings, and the roll angle signal, wherein the roll-rate threshold defines a minimum roll-rate at which the rollover collision operation is performed by the vehicle and a roll-rate indicates an angular velocity of the vehicle about the roll axis of the vehicle.

12. The system of claim 11 wherein the rollover calibration modules selects one of a first roll-rate threshold function and a second roll-rate threshold function based on the off-road signal and the speed signal, wherein the first roll-rate threshold function and the second roll-rate function define the roll-rate threshold as a function of a roll angle parameter, and wherein the rollover calibration selects the second roll-rate threshold function when the off-road signal indicates that the vehicle is operating in an off-road mode and the speed signal indicates that the speed of the vehicle is below a speed threshold.

13. The system of claim 12 wherein the deployment module receives the one of the first roll-rate threshold function and the second roll-rate threshold function and determines the roll-rate threshold by calculating the roll-rate threshold using the one of the first roll-rate threshold function and the second roll-rate threshold function and the roll angle of the vehicle indicated by the roll angle signal, wherein the deployment module substitutes the roll angle for the roll angle parameter.

14. The system of claim 12 wherein the first roll-rate threshold function is defined by:
ω_{MAX}=m₁θ+b₁
and the second roll-rate threshold function is defined by:
ω_{MAX}=m₂θ+b₂
where ω_{MAX} is the roll-rate threshold, m is a negative slope value, θ is the roll angle parameter, and b₁ and b₂ are offset values, wherein b₂ is greater than b₁.

15. The system of claim 11 wherein the deployment module monitors a roll rate signal indicative of a measured angular velocity of the vehicle about the roll axis of the vehicle, compares the measured angular velocity of the vehicle with the roll rate threshold, and initiates the rollover collision operation when the measured angular velocity of the vehicle exceeds the roll-rate threshold.

16. The system of claim 15 wherein, when the off-road signal indicates that the vehicle is in the off-road mode and the speed signal indicates that the speed of the vehicle is below a speed threshold, the rollover collision operation includes at least one of deploying at least one side airbag of the vehicle, deploying a pretensioner of at least one seatbelt of the vehicle, and deploying a reversible pretensioner of the at least one seatbelt of the vehicle.

17. The system of claim 11 wherein the rollover calibration settings include settings for disengaging a side airbag system of the vehicle when the off-road signal indicates that the vehicle is operating in an off-road mode and the speed signal indicates that the speed of the vehicle is below a speed threshold.

18. The system of claim 11 wherein the rollover calibration settings include allowing an engaged pretensioner of a seatbelt of the vehicle to disengage when the off-road signal indicates that the vehicle is operating in an off-road mode and the speed signal indicates that the speed of the vehicle is below a speed threshold.

19. The system of claim 11 wherein the off-road signal is comprised of a four wheel drive signal indicating whether the vehicle is in a two-wheel drive mode or a four-wheel drive mode and a gear signal indicating a current gear of the vehicle, wherein the four wheel drive signal is received from a transfer case control module of the vehicle and the gear signal is received from a transmission control module of the vehicle.
